(19) United States
(12) Patent Application Publication
(10) Pub. No.: US 2023/0303422 A1
(43) Pub. Date: Sep. 28, 2023

(54) COMPLEX GLAZING AND METHOD OF FORMING

(71) Applicant: AGP America S.A., Ciudad de Panama (PA)

(72) Inventors: Mario Arturo MANNHEIM ASTETE, Lima (PE); Jean Marie LE NY, Gemmenich (BE); Fabián VEGA, Lima (PE); Guillaume GÉRANTON, Lyon Ródano-Alpes (FR); Kubo TOMOYUKI, Lima (PE)

(21) Appl. No.: 18/040,808

(22) PCT Filed: Aug. 6, 2021
(86) PCT No.: PCT/IB2021/057287

§ 371 Date: Feb. 6, 2023

Related U.S. Application Data
(60) Provisional application No. 63/062,938, filed on Aug. 7, 2020.

(51) Int. Cl. C03B 23/023

(52) U.S. Cl. CPC C03B 23/023

(57) ABSTRACT

Automotive glazing has long been a factor which has frustrated and limited the freedom of automotive designers to embody their vision. The idealized initial design often must be changed and sometimes even radically altered due to the limitations on the shapes of glazing that can be produced due to the methods used to form the glazing. While sheet metal can be formed to just about any conceivable shape, glass is limited to relatively simple large radii cylindrical/spherical shapes. By means of a multi-stage forming method, it is possible to produce glazing with complex curvature, comprising small compound radii with excellent optical quality, that exceed the forming limits and dimensional accuracy of what has previously been possible.

### FIELD OF THE INVENTION

The invention relates to the field of automotive glazing.

### BACKGROUND OF THE INVENTION

One of the trends that has been developing over the last several years has been an increase in the size of the glazed area of automobiles. As automotive manufacturers have worked to improve energy efficiency, in response to government regulatory requirements and to satisfy the public demand for more environmentally friendly vehicles, the average size and weight of vehicles has been decreasing. Even full-size luxury sedans are not as spacious as they were not that many years ago.

The smaller cabin size can give the occupants a cramped and uncomfortable feeling. By increasing the glazed area, allowing more light to enter and providing a better view of the outside, the effect can be offset, and the occupant experience improved. The increase in the glazed area can also help fuel efficiency in that the glazed area tends to offset heavier materials helping to also reduce vehicle weight.

One area of the vehicle where this trend is especially evident is the roof. A panoramic roof is a roof glazing which comprises a substantial area of the roof covering at least a portion of both the front and rear seating areas of the vehicle. A panoramic roof may be comprised of multiple glazing and may be laminated or monolithic. Panoramic roofs are a very popular option and are available or even standard equipment on most models.

Windshields have also been getting bigger with some now in production which extend substantially upward into the roof line and wrap around further into the A-pillar area than more conventional windshields. We have even seen concept cars in which the windshield, roof and rear window have been combined into a single glazing.

There are a number of challenges resulting from this trend.

Automotive designers seek to maximize the aesthetic of the vehicle by having a unified design. The designers tend to carry body lines across the sheet metal from panel to panel and often along the entire length of the vehicle. We can clearly see this on many vehicles where a fold in the front fender is continued along the door and through to the rear. This also helps to improve the stiffness of the vehicle. Body panels also tend to be flush to each other and have minimal gaps panel to panel. In addition to the aesthetics, this also helps improve the aerodynamics of the vehicles by reducing turbulence and wind resistance.

The technology to form sheet metal into body panels has improved at a rapid rate with shapes routinely produced today that couldn't have been dreamed of not too many years ago. However, glass forming technology has not kept pace. Designers have been frustrated by the restrictions placed upon vehicle design by the limitations of the glass forming process. The large complex glazing on many show and concept cars is often fabricated from plastic rather than glass as the design would not be possible to produce with glass.

This is in part at least due to the fact that glass material properties are very different from the metal panels that they are used with. The primary one is the intrinsic property of metals being ductile while glass is a brittle material.

The term “glass” can be applied to many inorganic materials, including many that are not transparent. For this document we will only be referring to transparent glass. From a scientific standpoint, glass is defined as a state of matter comprising a non-crystalline amorphous solid that lacks the ordered molecular structure of true solids. Glasses have the mechanical rigidity of crystals with the random structure of liquids.

Glass is formed by mixing various substances together and then heating to a temperature where they melt and fully dissolve in each other, forming a miscible homogeneous fluid.

Most of the worlds' flat glass is produced by the float glass process, first commercialized in the 1950s. In the float glass process, the raw ingredients are melted in a large refractory vessel and then the molten glass is extruded from the vessel onto a bath of molten tin where the glass floats. The thickness of the glass is controlled by the speed at which the molten glass is drawn from the vessel. As the glass cools and hardens, the glass ribbon transfers to rollers.

Laminated Automotive safety glazing is made by bonding two sheets of annealed glass together using a thin sheet of a transparent thermo-plastic.

The types of glass that may be used to produce automotive glazing include but are not limited to: the common soda-lime variety typical of automotive glazing as well as aluminosilicate, lithium aluminosilicate, borosilicate, glass ceramics, and the various other inorganic solid amorphous compositions which undergo a glass transition and are transparent.

Steel and most metals are ductile at room temperature. That is, they can be bent or formed by subjecting the metal to stress. When the stress is removed the metal will retain its deformed shape. Glass, on the other hand is a brittle material, exhibiting near perfect elastic behavior. At room temperature, glass, when stressed may deflect but when the stress is removed, it will return to its original shape. If the level of stress is sufficient, the glass will break.

Metals and many other types of materials have an ultimate yield strength at which point the material will fail. However, with glass we can only specify a probability of breakage for a given value of stress. Looking at glass at the molecular level, we would expect the strength to be very high. In fact, what is found in practice is that glass has a very high compressive strength, as expected, but very low tensile strength.

For a given set of glass test specimens, with identical loading, the point of failure at first glance might appear to be a random variable. In fact, the modulus of rupture follows a Weibull distribution and the probability of breakage can be calculated as a function of, stress, duration, surface area, surface defects and the Young's modulus of glass.

To the naked eye, float glass appears to be near perfect. Any defects that may be present as so small as to not be visible. But, in fact, at the microscopic level, the surface appears rough and can be seen to be dotted with flaws. When the glass is placed in tension, these surface defects tend to open and expand, eventually leading to failure. Therefore, laminated automotive glass almost always fails in tension. Even when not in tension, the surface defects react with the moisture in the environment and slowly “grow” over time. This is known as slow crack growth.

When heated or cooled sufficiently glass undergoes a glass transition. When most materials go through a phase change, the change in state is abrupt and occurs as a precise temperature as the molecules go from moving around freely to being locked in place and vice versa. This is because all of the bonds between the molecules are identical and break at the same temperature.

In a glass, due to the random order of the molecules, the bonds are all different. The bond strength is a function of the stress on the bonds and temperature. As the material is heated, it reaches a point where some of the bonds just begin to break, and the glass starts to soften. As the temperature increases, more of the bonds continue to break and the glass becomes softer until it reaches its melting point, becoming a liquid. This range of temperatures where the glass transitions from a liquid to a solid, or vice-versa, is known as the glass transition range. The center of this range is defined as the glass transition temperature, Tg. The glass transition temperature and range are primarily a function of the composition of the glass, as well as the speed of cooling or heating

Glass containers are formed by heating the glass to the upper limits of the glass transition range or higher transforming the glass into a viscous liquid where it will take the shape of the mold.

Very few automotive glazings are flat. Most have curvature in at least one direction. Many have compound curvature, that is curvature in two directions. On many glazings, the curvature is not constant but varies.

To transform a flat sheet of glass into an automotive glazing panel it must be heated to at least the lower end of the glass transition range where plastic deformation can take place. The challenge in forming flat glass is bending it to the desired shape while maintaining the optical quality of the glass. If the glass is soft enough to undergo plastic deformation, it is soft enough for the tooling coming into contact with the hot soft glass to leave a mark. This requires precise control of the glass temperature and careful design of the tooling, the materials and methods used to construct it. The glass must be heated to no more than required to allow it to bend to the desired shape. Otherwise, marking of the glass may occur which may result in aesthetically objectionable artifacts such as mold mark where the mold comes into contact with the glass. Optical distortion can appear if the glass does not bend in the intended manner.

At the glass forming or bending temperatures, the glass is malleable but still relatively stiff. As the glass bends, it is placed in tension and compression. If the levels of stress become too high, rather than bend as desired, the glass will tend to fold, wrinkle and distort. These stress limits are well understood and can be predicted. The limits are primarily a function of the glass composition, the forming or bending temperature, the glass thickness and the curvature. Generalized rules of thumb can be applied. More precise and detailed analysis can be done using finite element analysis, FEA.

At forming temperatures, most shapes, thicknesses and glass compositions can be subjected to up to 100 MPa of tensile stress without distortion or breakage. This limit remains a probabilistic function which is also determined not just by the maximum stress but also the rate at which the stress is applied and the duration.

Due to these limitations, new glazing designs must often be simplified in order to become feasible for serial production.

A number of forming methods have been developed in an effort to overcome these limitations.

Early bending ovens were gas fired and heated the glass in a fairly isothermal manner using convective heat transfer. Today, most make use of resistive electrical heating elements and radiant heat with the elements divided into small zones that can be precisely controlled. Some bending ovens have hundreds of separately controlled heating elements. The separate control allows the glass to receive more heat in the areas where more bend is needed.

Gravity bending makes use of the force of gravity acting upon the weight of the glass to form it. The flat glass is supported at just the periphery, typically from 4 mm to 10 mm inboard from the edge of glass, by a metal ring formed to the final design shape of the glass. Both of the two glass layers are placed upon a single ring mold and formed simultaneously. This is known as doublet gravity bending. As the glass is heated, the glass will tend to sag taking on the shape of the ring. For more complex glazing, the ring is often articulated with counterweights used to allow the articulated movable portions of the ring to move from the open flat position to the final closed position. Elaborate methods have been developed to produce complex shapes by means of gravity bending using thermal ballast, heat shields and complex mechanical mechanisms.

Gravity bending was used almost exclusively for many years to bend mass series production windshield due to the low cost of the initial tooling and high throughput of the process.

Gravity bending tends to produce a shape that will fit the design opening, tangent to the sheet metal and close to the design shape near the edge of glass where the glass is supported during forming, but relatively flat further inboard. Surface match between the two glass layers is very good as both are formed at the same time. However, gravity bending is also very limited as far as its ability to produce glazing with smaller radii and complex compound curvature.

Many methods have been developed in an attempt to overcome the limitations of gravity bending. All make use of the same type of articulated ring mold and gravity bending as the first step of the process. Then, once the glass has reached the limit of what can be done with gravity alone, further force is applied to the glass by means of: vacuum, air pressure, partial surface pressing, full surface pressing or some combination.

While these methods produce glazing that has more complex curvature, they cannot approach the complexity, accuracy or surface control that can be achieved with sheet metal.

To further improve upon and exceed the limitations of the gravity bending process, the full surface singlet as well as doublet or more pressing method was developed. This is very similar to the process used to manufacture monolithic tempered glass. Flat sheets of glass are formed on a full surface press, one at a time, and then cooled to freeze the shape. Surface control is very good. While much tighter tolerances can be achieved, this method also has its drawbacks. As the two glass layers are produced separately, there can be more variation from the glass layer to layer in the same laminate. While more complex shapes can be produced, the same limitations still come into play as some point.

With all of the processes discussed some shapes are still very difficult if not impossible to form. The general minimum radius of curvature is around ^{˜}200 mm. Compound curvature, that is curvature in more than one direction, can be even more difficult. If the maximum radius is large, and the minimum is relatively small, the bend may be feasible. However, if both are relatively small, the part is most likely not manufacturable by any of the mentioned methods.

The depth of bend 26 shown in FIG. 9 is the depth of the smallest box that the glazing will fit in. The deeper the box, the more bend that the glazing has and the more difficult it will be to manufacture. The limitations of the prior art vary depending upon the curvature and complexity of the glazing. Windshields with a depth of bend in excess of 100 mm were produced in the 1950s. These panoramic windshields wrapped around well into the A-pillar but had a larger radius in the vertical direction.

Centerline cross bend 28 is another important parameter used to define the complexity of a glazing. For clarity purposes, the centerline cross bend 28 corresponds to the maximum perpendicular distance to the vertical centerline of a cord running from the top edge to the bottom edge of the panoramic windshield. These panoramic windshields had a centerline cross bend of nearly zero. Gravity bending alone can produce glazing with a centerline cross bend of up to 15 mm. The various enhanced versions of gravity bending can produce glazing with a centerline cross bend of up to 30 mm. These are approximate values. The actual limitations will vary with the exact method, composition and complexity of the glazing.

It is also exceedingly difficult to produce a shape that is both concave and convex on the same surface.

The root cause of these limitations is that hot glass tends to distort if placed in compression. In tension, the glass will stretch and become thinner but when placed in compression it does not tend to thicken. Rather, it will deflect resulting in wrinkles and distortion. This is analogous to pushing and pulling on a rope.

While wrinkles are generated due to too much compression (buckling), the wrinkles result in high tension that may result in glass breakage. Glass has very high compressive strength but easily breaks under relatively low tension. In some shape with high curvature only in one direction the bending is directly limited by the resulting forces induced in pressing even when wrinkles are not being generated.

When a windshield is formed, the interior facing surface of the glass tends to be placed in compression whereas the exterior surface being place in tension gets slightly larger due to the outer glass surface stretching and the glass becoming slightly thinner locally.

The hot glass can accommodate some compression. Fortunately, it is possible to predict by ways of simulation the level of compression that will result from various forming methods to achieve a given shape. This allows to quickly determine if a shape is possible or not with a given method of forming.

Due to these limitations, show and concept cars have often been produced with plastic glazing which can easily be formed to complex shapes. However, plastic is not suitable for production vehicles as it does not meet various safety regulations, is not as durable nor does it have the same optical quality as glass.

One approach developed is disclosed in document U.S. Pat. No. 9,656,537 B2, which makes use of a multiple stage bending process where the final shape is approached in an incremental manner. This document is intended to achieve complex shapes in a windshield having a flat surface in the central section and two side sections with complex geometries. The document requires a pre-bending step, then a gravity bending step that achieves 5% to 40% of the final bend, the next step lifts the glazing by a convex suction device to a pre-bending region and bend to 102% to 130% of the final bend, then the glazing is pressed against a concave mold, and the final step is the bending by gravity to the final bend and then cooled.

As can be noted, the prior art bends the glazing at one stage in the process, over bending the glass. Over bending depends upon the assumption that the over bent glass will snap back in a predictable and repeatable manner. This is very much dependent upon the glass composition, thickness, temperature profile and other variables that can be difficult to control. Over bending runs the risk of breakage, high residual stress, wrinkles and optical defects.

The mix of technologies, dependence on gravity bending, and over bending achieve mixed results. Complex shapes with compound bend, greater centerline cross bend 28 and depth of bend 26 as illustrated in FIG. 9 can be formed but the tooling cost is high and small radii compound curvature is still difficult to achieve.

It would be highly advantageous to be able to form more complex shapes and to overcome these limitations.

### BRIEF SUMMARY OF THE INVENTION

The limitations of the prior art are overcome by a method in which a glass having complex geometries can be formed by a mechanism consisting of a series of multiple, sequential and back to back heating and bending stages (forming stages). Each stage comprises at least one step of heating and press bending a portion of glass until the final complex geometry is achieved. During each forming stage, the glass is partially formed. The stages are repeated until the final desired shape is achieved. The number of stages used is selected such that the stress levels in the glass during pressing at each stage remains below 100 MPa that correspond to the limit known to result in defects and breakage. The number of stages is at least two and may be as many as needed.

The glass leaving each stage feeds directly into the next stage. At each stage the hot glass is at least partially formed by any press means. Partial or full surface means as well as male or female press bending techniques may be used. Upon exit, the partially formed glass exiting each stage enters the next bending step in order to continue the bending stage to the final shape. In additional embodiments, the temperature of the glass may drop between stages, but does not drop significantly below the lower end of the glass transition range. The partially formed glass exiting each stage enters the next where it can be quickly reheated to relieve stress from the last stage and to prepare for the next bending step.

If the stress during pressing is sufficiently low, the temperature profile of the glass can be reduced, increasing the viscosity and potentially improving the optical quality.

After the last stage, the glass may be annealed, heat strengthened or tempered.

The forming technology used for each stage is substantially the same. However, it should be noted that any bending techniques may be combined with press bending to achieve the glass final shape. In each stage, for example, vacuum assisted pressing may be used to bend the glass.

A set of support rings may be used to convey the glass through the process. Depending upon the complexity of the shape, the same support ring may be used at more than one stage and even through the entire process. Some shapes may require though different support rings for each stage or different surface molds for press bending the glass.

One of the achievements of the present disclosure is the quantification of the amount of pressure needed to achieve the final shape of the glass, which is split into different stages so that the glass is not overbent but approaches the final shape in increments that do not exceed the pressing stress limits onto the glass of 100 MPa. At a single bending stage, the forming may be primarily curvature in the vertical direction while at another, it may be in the horizontal. The shape may also be reached by analyzing the shape at incremental percentages of bend. It should be noted that a combination of horizontal with vertical bending directions can be accomplished in a single bending stage indistinctly.

The partial bending will be shape dependent and is best optimized by means of computer simulation such as FEA or CAD. Accordingly, it is possible to produce the most complex of shapes including those with small radii compound curvature, concave/convex surfaces, progressive bending and other advanced features previously difficult or impossible to economically mass produce.

Another objective of the present invention is to provide a vehicle glazing manufactured according to the method disclosed by the present disclosure.

### Advantages

Economic production of glazings having complex shapes
Lower tooling cost
Concave/convex shape capability
Small radii compound curvature capability
Complex shape capability
Progressive bend capability
Able to produce glazing with excellent surface control
Excellent optical quality
High yield

### BRIEF DESCRIPTION OF THE SEVERAL VIEWS OF THE DRAWINGS

FIG. 1A shows a cross section of a typical laminated automotive glazing

FIG. 1B shows a cross section of a typical laminated automotive glazing with performance film and coating

FIG. 1C shows a cross section of a typical tempered monolithic automotive glazing

FIG. 2 is a flow chart illustrating the steps of the method.

FIG. 3 is a four-stage forming process.

FIG. 4A is an isometric view of a glazing produced by the method.

FIG. 4B is a front view of a glazing produced by the method.

FIG. 5A is a top view of a glazing produced by the method.

FIG. 5B is a side view of a glazing produced by the method.

FIG. 6A is a horizontal Section AA, running from the bottom A pillar tips, at 0, 20,30, 40, 50, 60, 70, 80, 90 and 100% of bend.

FIG. 6B shows the vertical centerline sections (Y=0) at 0, 20,30, 40, 50, 60, 70, 80, 90 and 100% of bend. The rear edge of the glazing is to the left looking at the figure.

FIG. 7A shows the horizontal Section B, in the transition from the windshield to the roof, at 0, 20,30, 40, 50, 60, 70, 80, 90 and 100% of bend.

FIG. 7B shows the vertical sections (Y=600) at 0, 20,30, 40, 50, 60, 70, 80, 90 and 100% of bend. The rear edge of the glazing is to the left looking at the figure.

FIG. 8 is an isometric view of the full surface at 40, 60, 80 and 100% of bend.

FIG. 9 is a side view of the full surface at 40, 60, 80 and 100% of bend.

FIG. 10 is a front view of the full surface at 40, 60, 80 and 100% of bend.

### REFERENCE NUMERALS OF DRAWINGS

2 Glass
4 Bonding/Adhesive layer (plastic Interlayer)
6 Obscuration/Black Paint
12 Infrared reflecting film
20 Infrared reflecting coating
24 Region of minimum compound curvature
26 Bounding Box/Depth of bend
28 Centerline cross bend
31 Constant X
32 Constant Y
33 Constant Z
40 Flat glass
41 10% of bend
42 20% of bend
43 30% of bend
44 40% of bend
45 50% of bend
46 60% of bend
47 70% of bend
48 80% of bend
49 90% of bend
50 100% of bend
51 Forming section 1
52 Forming section 2
53 Forming section 3
54 Forming section 4
61 Heating section 1
62 Heating section 2
63 Heating section 3
64 Heating section 4
71 Annealing zone
101 Exterior side of glass layer 1 (201), number one surface.
102 Interior side of glass layer 1 (201), number two surface.
103 Exterior side of glass layer 2 (202), number 3 surface.
104 Interior side of glass layer 2 (202), number 4 surface.
201 Outer glass layer
202 Inner glass layer

### DETAILED DESCRIPTION OF THE INVENTION

The following terminology is used to describe the laminated glazing of the invention.

A glazing is an article comprised of at least one layer of a transparent material which serves to provide for the transmission of light and/or to provide for viewing of the side opposite the viewer and which is mounted in an opening in a building, vehicle, wall or roof or other framing member or enclosure.

Laminates, in general, are articles comprised of multiple layers of thin, relative to their length and width, material, with each thin layer having two oppositely disposed major faces, typically of relatively uniform thickness, which are permanently bonded to one and other across at least one major face of each layer. The layers of a laminate may alternately be described as sheets or plies. In addition, the glass layers may also be referred to as panes.

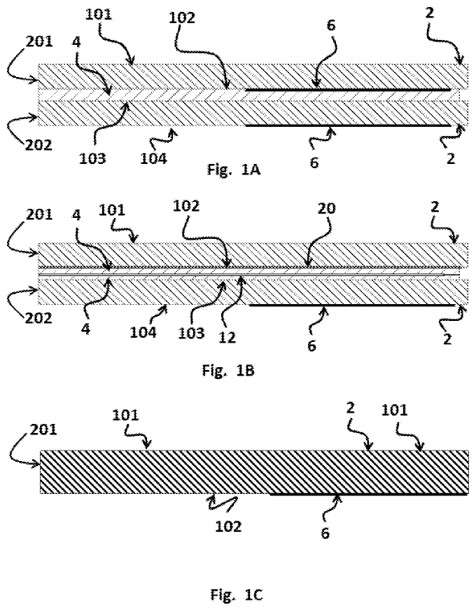

Laminated safety glass is made by bonding two layers, an exterior layer 201 and an interior layer 202 of annealed glass 2 together using a plastic bonding layer comprised of a thin sheet of transparent thermoplastic 4 (interlayer) as shown in FIG. 1A and 1B.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic layer 4 also helps to prevent penetration by objects striking the laminate from the exterior and in the event of a crash occupant retention is improved.

Typical automotive laminated glazing cross sections are illustrated in FIGS. 1A and 1B. In a laminate, the glass surface that is on the exterior of the vehicle is referred to as surface one 101 or the number one surface. The opposite face of the exterior glass layer 201 is surface two 102 or the number two surface. The glass 2 surface that is on the interior of the vehicle is referred to as surface four 104 or the number four surface. The opposite face of the interior layer of glass 202 is surface three 103 or the number three surface. Surfaces two 102 and three 103 are bonded together by the plastic layer 4. An obscuration 6 may be also applied to the glass. Obscurations are commonly comprised of black enamel frit printed on either the number two 102 or number four surface 104 or on both. The laminate may have a coating 20 on one or more of the surfaces. The laminate may also comprise a functional film 12 such as solar control film laminated between at least two plastic layers 4.

The types of glass that may be used include but are not limited to: the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings.

For the purpose of this document, a stage corresponds to the set of steps required to complete a single heating and bending cycle. Rather than bending the glass to its final shape in a single stage, multiple heating/bending stages are used. During each stage the glass is at least partially formed. The stages are repeated until the final desired shape is achieved. The present disclosure can use different bending technologies combined in order to achieve the complex shapes by any bending process, for instance, may use a combination of gravity bending, full or partial surface male or female press bending and full or partial surface pressing with both a male and a female press.

FIG. 1C shows a typical tempered automotive glazing cross section. Tempered glazing is typically comprised of a single layer of glass 201 which has been heat strengthened. The number two surface 102 of a tempered glazing is on the interior of the vehicle. An obscuration 6 may be also applied to the glass. Obscurations are commonly comprised of black enamel frit printed on the number two 102 surface. The glazing may have a coating 20 on the number one 101 and/or number two 102 surfaces as shown in FIG. 1B.

The glass layers of a laminate glazing may be annealed or strengthened. There are two processes that can be used to increase the strength of glass. They are thermal strengthening, in which the hot glass is rapidly cooled (quenched) and chemical tempering which achieves the same effect through an ion exchange chemical treatment.

Heat strengthened, full temper soda-lime float glass, with a compressive strength in the range of at least 70 MPa, can be used in all vehicle positions other than the windshield. Heat strengthened (tempered) glass has a layer of high compression on the outside surfaces of the glass, balanced by tension on the inside of the glass which is produced by the rapid cooling of the hot softened glass. When tempered glass breaks, the tension and compression are no longer in balance and the glass breaks into small beads with dull edges. Tempered glass is much stronger than annealed laminated glass. The thickness limits of the typical automotive heat strengthening process are in the 3.2 mm to 3.6 mm range. This is due to the rapid heat transfer that is required. It is not possible to achieve the high surface compression needed with thinner glass using the typical blower type low pressure air quenching systems.

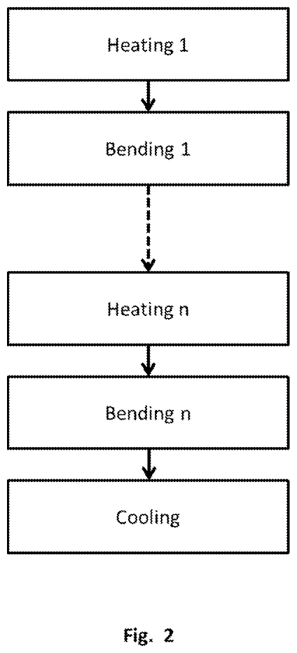

FIG. 2 shows a flow chart illustrating the steps employed by the method of the present disclosure. A first stage comprises a first step of heating the glass to the bending temperature and a second step of press bending the glass.

Rather than attempting to bend the glass to its final shape in a single stage as proposed by the prior art, the present disclosure partially forms the glass in at least two stages, each stage comprised by a heating and press bending steps. The process repeats the stage of two steps until the final shape is achieved. The number of heating and bending stages required is variable and denoted as n. A minimum number of stages n=two stages are required.

The number of stages required is determined through an iterative analysis of the stress generated by the bending. Assisted FEA/CAD code can be generated to calculate several surfaces, defining intermediate levels of bend between the flat and design shape. Using a FEA code, the stress is analyzed at each increment to find a surface that allows to partially bend the glass without exceeding 100 MPa at each forming stage which is the maximum level of stress a glass can withstand when pressed that would result in defects for breakage. This process is then repeated to find the next incremental surface until the final design shape is reached.

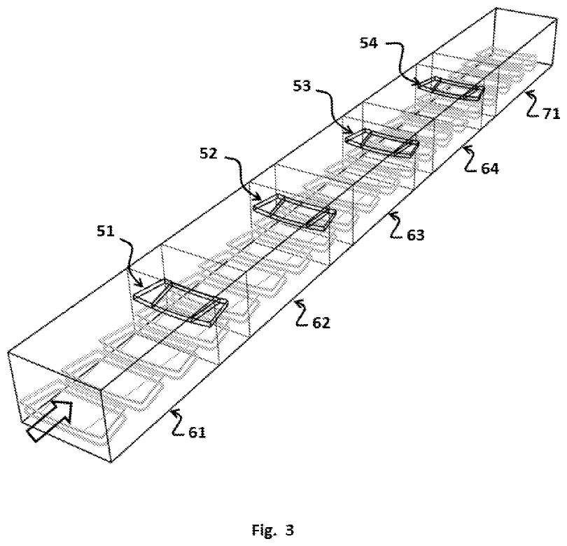

The stages are assembled such that the glass exiting each stage feeds into the next stage. In this manner, the hot glass exits each forming stage and is immediately conveyed into the heating section of the next stage. Advantageously, the heating pattern can be altered for each stage so as to optimize the viscosity of the glass for forming. In the second forming stage, the glass is again partially formed. The process repeats until the final design shape is achieved. The method requires at least two heating and bending stages. The heating and bending stages can be performed in inline sequential heating sections, such as those illustrated in FIG. 3, or can also be performed in a single chamber, so that the glass remains in the chamber, where the bending technique is adapted to incrementally change the shape of the glass.

In the flow chart, the number of stages is designated by the variable “n.” By repeating the heating and bending steps, the final otherwise infeasible shape may be achieved by approaching the final shape in increments where the material and process limits are not exceeded at any one stage.

The method of the invention may be practiced with any type of heating or bending means. The glass may be heated by convective, conductive, radiant, electromagnetic or any combination of heating means. Single or multiple glass layers may be simultaneously formed at each forming stage. The forming method may use the various methods known in the art of gravity bending, full surface and partial surface bending as well as combinations thereof. The bending method may further utilize vacuum and or pressure in conjunction with the other mentioned methods. The glass may be annealed, heat strengthened or fully heat tempered after the last forming stage.

In this manner, complex glazings such as one with a surface area in excess of 1.5 square meters and/or a depth of bend of at least 100 mm, and a radius of curvature less than 500 mm in one direction and less than 2,000 mm in the direction perpendicular to the smaller first minimum radius may be produced. Glazings which are substantially symmetrical, such as windshields, backlites and roofs may be produced by the method of the invention which have a centerline of symmetry cross bend of at least 100 mm.

### DESCRIPTION OF EMBODIMENTS

### Embodiment 1

A conceptual drawing of an embodiment with four stages is shown in FIG. 3. For the sake of simplicity, the pressing equipment is not shown, but should be noted that a male or female press bend may be used. Note that the Figure is not to scale and is only intended to illustrate the concept. A bending process for automotive glass is equipped with four inline sequential heating sections, 61, 62, 63 and 64, and four inline sequential bending sections, 51, 52, 53 and 54, as illustrated in FIG. 3. Each heating section is equipped with roof mounted resistive radiant heating elements divided into zones. The heating elements of each zone are further subdivided into multiple separately controlled circuits to allow for fine control of the temperature profile across the glass.

The glass is conveyed through the process on an articulated ring type mold enclosed in a movable insulated box. The boxes are sized to span one heating zone each. During operation, the boxes move through the heating portion. The boxes remain stationary for a period of time in each zone before being advanced to the next. In this manner the glass is heated to the bending or softening temperature and then moved to the next stage. In order to ensure the correct distribution of temperature to the glass, the bending temperature has been increased by 20° C. and then slightly cool down to press the glass. In this embodiment, the bending temperature was 600° C. where press was applied in each forming stage. The bending temperature is determined by the composition of the glass.

In this embodiment, each forming stage comprises at least a heating section and a full surface male press forming section. A variation of the present embodiment may comprise different surface molds for press bending the glass in each press bending stage. The hot glass is at least partially formed by each stage. The press surface mold is designed to form the glass without exceeding the physical limits of the glass which could result in defects, breakage, distortion or marking. The press surface mold is covered with a pliable material so as to not mark the glass. The face is also provided with holes connecting to a plenum in the back of the press which is used to apply vacuum during the bending process. The vacuum pulls the hot glass tightly to the press surface mold, eliminating the need for an opposite side female press.

The press mold shape and temperature profile for each stage is critical to the method. Computer simulation, FEA and CAD, is used to determine optimal parameters.

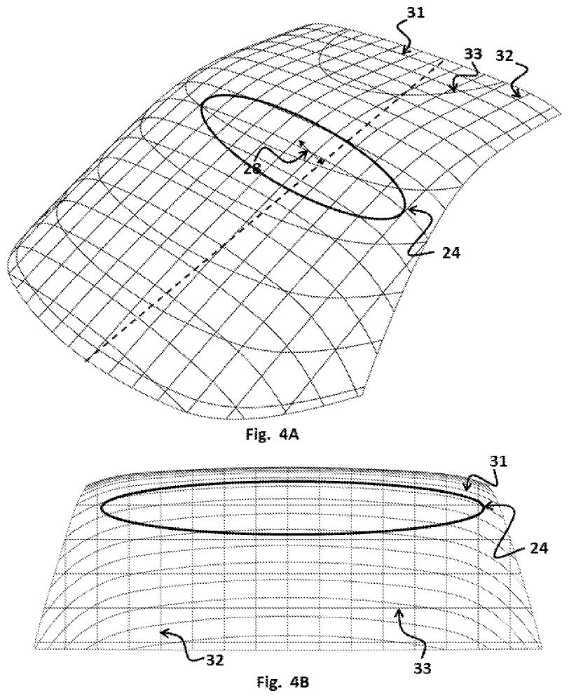

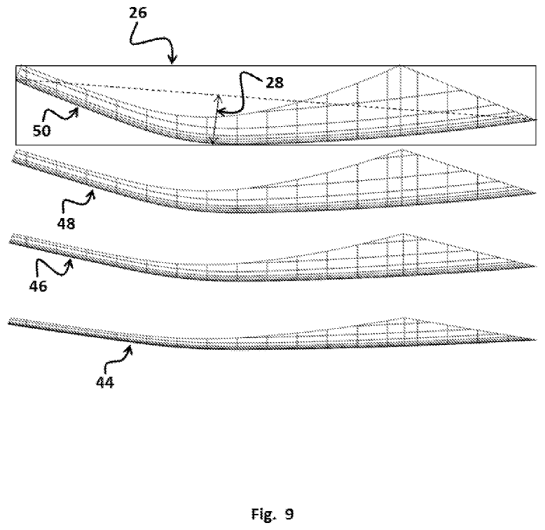

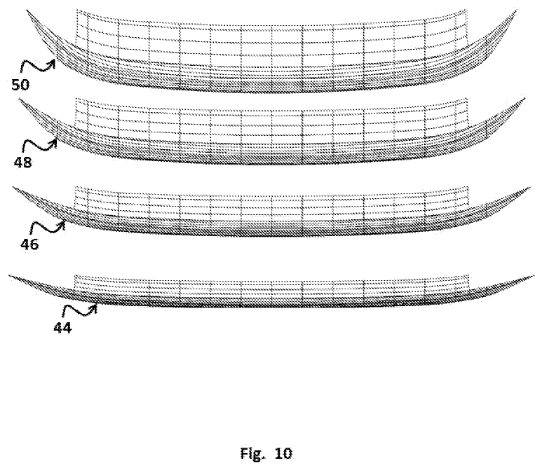

FIGS. 4 to 10 show various aspects of a glazing produced by the method of the invention. The glazing illustrated is a large complex symmetrical panoramic windshield where the top of the windshield has been extended to include a substantial portion of the roof.

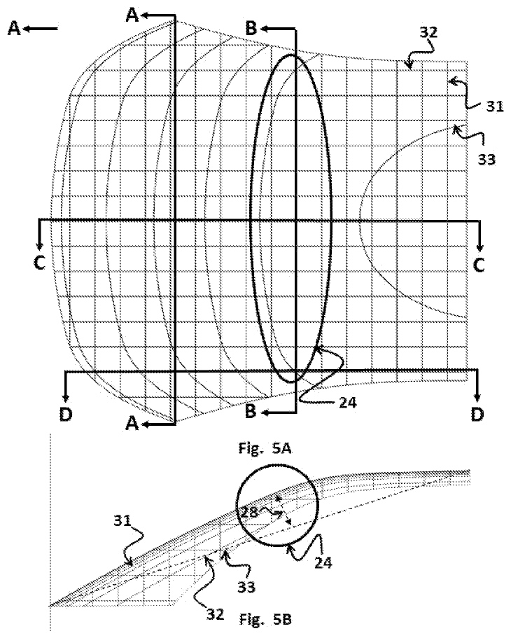

With the four corners of the formed glazing in a plane, the depth of bend of the part is 260 mm. The area of the formed shape is 2.5 m². The area denoted by the oval 24 in FIGS. 4A, 4B, 5A, is where the maximum stress and minimum radii occur. The minimum radius of the part is 400 mm. The direction of the minimum radius is horizontal or left to right from the drivers' viewpoint. In the direction perpendicular to the minimum radius (vertical or front to rear), the minimum radius is 1,000 mm.

Adding to the complexity, this part has a vertical centerline 28 (centerline of symmetry) cross bend of 150 mm. This part would be difficult if not impossible to economically produce by any other means.

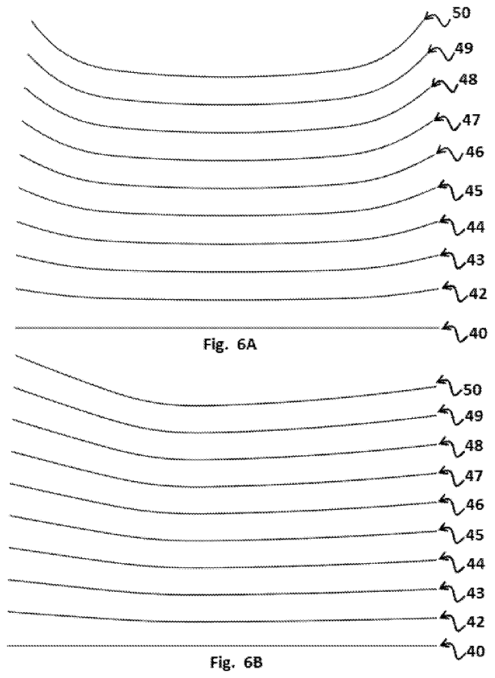

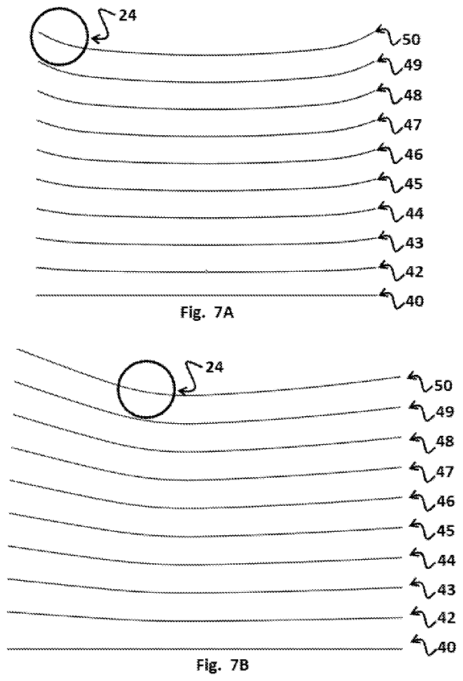

To evaluate the feasibility of this part a set of 10 subsequent surfaces were simulated using FEA and CAD. Starting with the flat glass and ending with the final shape, surfaces representing increments of 10% in bending were produced. Section curves are shown in FIGS. 6A, 6B, 7A and 7B. Each of these sections are shown at 0, 20, 30, 40, 50, 60, 70, 80, 90 and 100% of bend (numerals 40, 42, 43, 44, 45, 46, 47, 48, 49 and 50). Starting with the flat surface, the stress required to achieve each percentage of bend was calculated but maintaining the stress levels in the glass at each stage below 100 MPa.

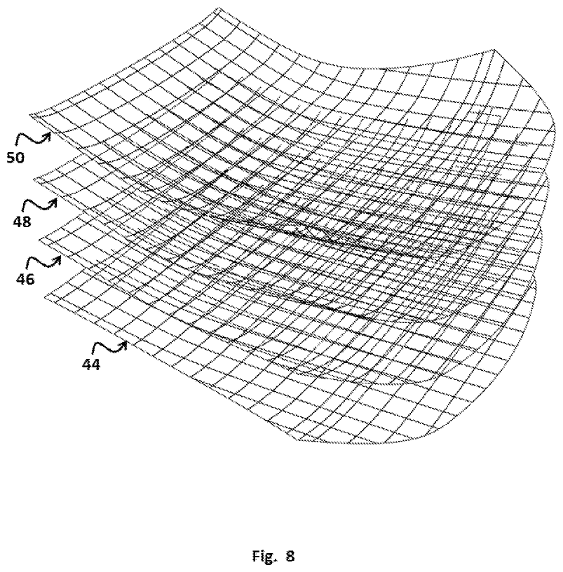

Based upon this result, 40% of the bend 44 was selected for the first bending increment. Using the 40% bending 44 as the next starting point and assuming zero strain resulting from the reheating, the analysis was repeated. 60% of the bending 46 was selected for the second bending increment. The calculations were then repeated a third and fourth time arriving at 80% of the bending 48 for the third increment. At each of the four bending increments, the compression is minimized and kept well below 100 MPa which is the critical level at which defects would be likely. The simulated surfaces can be seen in FIGS. 8, 9 and 10.

As the glass progresses through the bending process it approaches the final design shape, 100% of bend 50, each of which is obtainable without exceeding the limits of the process.

The maximum stress at each bending stage was incremental as of 50, 66, 70 and 70 MPa, well under the 100 MPa rule of thumb. It should be noted that each bending stage does not necessarily need to have an incremental value but can differ depending on the complexity of the shape required in each stage. Bending the flat glass to the final design shape in a single stage would generate maximum stress in excess of 300 MPa and not be successful, generating wrinkles resulting in the distortion of the glass and glass breakage.

Upon exiting the final stage, the glass enters a cooling section 71 where the glass may be annealed to release internal stresses.

### Embodiment 2

A second embodiment not illustrated consists of seven stages. The bending process is equipped with seven sequential heating sections. Each section equipped with roof mounted resistive radiant heating elements divided into zones. The depth of bend is 290 mm, the area of the formed shape is 2.8 m². The minimum radius of the part is 380 mm. The direction perpendicular to the minimum radius (vertical or front to rear), the minimum radius is 1,100 mm. The vertical centerline 28 (centerline of symmetry) cross bend of 190 mm.

The FEA and CAD simulations provided the following increment in shapes: first increment of 20% of the bending, the second increment of 40%, the third increment of 60%, the fourth increment of 65%, the fifth increment of 78%, the sixth increment of 91% and the seventh increment of 100%. The maximum stress at each bending stage was as of 40, 70, 55, 90, 40, 85 and 90 MPa. Upon exiting the final stage, the glass enters a cooling section 71 where the glass may be annealed to release internal stresses. In this embodiment, a single heating chamber may be used, allowing the use of different surface molds in each press bending stage.

It must be understood that the present disclosure is not limited to the embodiments described and illustrated, as it will be obvious for an expert on the art, there are different variations and possible modifications that do not strive away from the disclosure's essence, which is only defined by the following claims.

What is claimed is:

1. A method for forming an automotive glazing with high complexity geometry, comprising the following steps:
heating at least one glass layer to its forming temperature;
bending the glass layer to the high complex geometry shape by not exceeding the maximum stress during pressing at which defects occur; and
repeating the previous steps at least two times until the final shape of the high complexity geometry is achieved.
repeating the previous steps n times until the final shape of the high complexity geometry is achieved, wherein n is at least two.

2. The method of claim 1, wherein the bending step is selected from any of the following group of technologies: gravity bending, full surface male or female press bending, vacuum assisted male or female press bending and the combination thereof.

3. The method of claim 1, wherein the maximum stress during pressing is 100 MPa.

4. The method of claim 1, wherein the bending step is carried out using different surface molds in each press bending stage.

5. The method of claim 1, wherein the automotive glazing forming steps are optimized by means of computer simulations such as FEA or CAD.

6. The method of claim 1, wherein the number of repetitions of the automotive glazing forming steps are calculated using computer simulations such as FEA or CAD.

7. The method of claim 1, wherein a ring type support is used to convey the glass through at least one stage of the method.

8. The method of claim 1, wherein the forming steps of the automotive glazing are assembled such that the glass exits each stage and enters the next stage without allowing the glass to cool to a temperature that is substantially below the glass transition range.

9. The method of claim 1, wherein the number of forming stages is n wherein n is an integer number greater than one and corresponds to the number of increments required to bend the glass to the design shape without exceeding 100 MPa during pressing.

10. The method of claim 8, wherein the number of forming stages n is at least three, more preferably at least four, more preferably at least five, more preferably at least six, more preferably at least seven.

11. The method of claim 1, wherein the automotive glazing is subjected to an annealed, heat strengthened or fully heat tempered process after carrying out all the heating and bending steps.

12. The method of claim 1, wherein the maximum stress at each bending step can be incremental but not exceeding 100 MPa.

13. The method of claim 1, wherein after repeating the stages n times, the formed glazing comprises the following features:
at least one surface area of at least 1.5 square meters;
a depth of bend of at least 100 mm;
a minimum radius of less than 500 mm; and
an additional portion with a radius in the direction perpendicular to the first portion with a minimum radius of curvature of less than 2,000 mm.

14. A method for forming an automotive glazing with high complexity geometry, comprising the following steps:
a. heating at least one glass layer to its forming temperature;
b. bending the glass layer to the high complex geometry shape by not exceeding the maximum stress during pressing at which defects occur; and
repeating the bending step n times until the final shape of the high complexity geometry is achieved, wherein n is at least two.

15. The method of claim 12, wherein the repeating step further comprises reheating the glass layer prior to bending.

16. A vehicle glazing, comprising:
1. at least one glass layer having a high complexity geometry shape;
wherein the at least one glass layer has at least one surface area of at least 1.5 square meters;
wherein at least one glass layer has a depth of bend of at least 100 mm;
wherein at least one glass layer has a minimum radius of less than 500 mm; and
wherein at least one glass layer has an additional portion with a radius in the direction perpendicular to the first portion with a minimum radius of curvature of less than 2,000 mm.

17. The vehicle of claim 16, wherein the automotive glazing comprises a surface area in excess of 1.5 square meters, a depth of bend of at least 100 mm, and a radius of curvature less than 500 mm in one direction and less than 2,000 mm in the direction perpendicular to the smaller first minimum radius.

18. The vehicle glazing of claim 16, wherein the glazing is a laminated glazing comprising at least one glass layer and at least one plastic interlayer.

19. The vehicle glazing of claim 16, wherein the glazing is a laminated glazing comprising at least two glass layers and at least one plastic interlayer; said at least two glass layers having different thicknesses.

20. The vehicle glazing of claim 16, wherein the at least one glass layer is selected from the group of: soda-lime, aluminosilicate, lithium aluminosilicate, borosilicate, glass ceramics, and the combination thereof.

21. A vehicle glazing manufactured according to the method of claim 1.
